(19) United States
(12) Patent Application Publication
(10) Pub. No.: US 2026/0052375 A1
(43) Pub. Date: Feb. 19, 2026

(54) ACQUIRED-INFORMATION OUTPUT TERMINAL, ACQUIRED-INFORMATION OUTPUT SYSTEM, AND COMMUNICATION METHOD FOR ACQUIRED-INFORMATION OUTPUT TERMINAL

(71) Applicant: NEXT INNOVATION INC., Minato-ku, Tokyo (JP)

(72) Inventor: Hiroshi Michiwaki, Minato-ku, Tokyo (JP)

(21) Appl. No.: 19/102,153

(22) PCT Filed: Aug. 8, 2023
(86) PCT No.: PCT/JP2023/028875

§ 371 Date: Feb. 7, 2025

(30) Foreign Application Priority Data
Aug. 9, 2022 (JP) 2022-126721
Aug. 25, 2022 (JP) 2022-134000

(51) Int. Cl. H04W 8/22; H04W 4/80

(52) U.S. Cl. CPC H04W 8/22; H04W 4/80

(57) ABSTRACT

An acquired-information output terminal that acquires only information output by a specific device includes: a first acquisition unit for acquiring an identifier corresponding to the specific device; and a second acquisition unit that is different from the first acquisition unit and uses the identifier acquired by the first acquisition unit for establishing external communication that allows the information output by the specific device to be acquired using the identifier acquired by the first acquisition unit and acquiring the information, the second acquisition unit being different from the first acquisition unit.

### CROSS-REFERENCE TO RELATED APPLICATIONS

This application is a national phase entry under 35 U.S.C. § 371 of International Patent Application PCT/JP2023/028875, filed Aug. 8, 2023, designating the United States of America and published as International Patent Publication WO 2024/034596 A1 on Feb. 15, 2024, which claims the benefit under Article 8 of the Patent Cooperation Treaty of Japanese Patent Application Serial No. 2022-126721, filed Aug. 9, 2022, and to Japanese Patent Application Serial No. 2022-134000, filed Aug. 25, 2022.

### TECHNICAL FIELD

This disclosure relates to an acquired-information output terminal, an acquired-information output system, and a communication method for an acquired-information output terminal, for communicating with a specific device among multiple devices, acquire information, and output the acquired information.

### BACKGROUND

In recent years, with the remarkable spread of information communication terminals, the number of communication-enabled terminals has been increasing. Among these, mobile terminals and so-called IoT devices, or the like, are expanding their applications and numbers daily. Although they establish communication networks with each other, there are cases where communication cannot be opened between non-paired terminals or devices, particularly only between designated terminals or devices selected from multiple or numerous ones, whether specific or non-specific. For example, such a situation arises when multiple or numerous devices are present within a certain distance, and it is difficult to distinguish them by appearance and those devices are communication-enabled but not paired. In this case, while a list of multiple IDs may be displayed as candidates of devices capable of pairing, it is impossible to identify the ID of the designated device in a physical space, making it impossible to pair with the designated device. Consequently, there has been a situation where it is impossible to establish one-to-one communication between the designated device in physical space and the terminal specifying it.

Additionally, conventionally, there has been known a monitoring system in which multiple sensors are installed on a structure, measurement information is acquired by a reader via a wireless tag of each sensor, and the reader transmits the identification information of the wireless tag and the measurement information to a user terminal, which detects the sensor or structure to be notified based on the measurement information (for example, see Japanese Unexamined Patent Application Publication No. 2015-050739).

### BRIEF SUMMARY

### Problems to Be Solved by This Disclosure

However, the monitoring system described in Patent Document 1 has the problem that although the reader acquires measurement information from each wireless tag, the contents cannot be confirmed without the user's terminal. Moreover, even if the reader can confirm the measurement information and the identification information of the wireless tags, a problem arises when multiple or numerous wireless tags communicable with the reader are present simultaneously, making it impossible to distinguish a specific sensor on-site. Furthermore, when multiple users operate or perform tasks simultaneously on the same group of sensors, it becomes challenging to determine whose reader is receiving and displaying the measurement information of which sensor. Additionally, in a situation where many unpaired communication sensor devices are present within a single area, from among some of the communication devices that transmit some information, identifying a specific device that is transmitting particular information, i.e., that is detecting one or more abnormalities, has been extremely difficult.

In light of these issues, this disclosure was achieved through diligent research and provides a means to identify a specific communication sensor device and acquire only the information output from that communication sensor device, even when multiple communication sensor devices are present in a single area.

An acquired-information output terminal of the disclosure is an acquired-information output terminal that acquires only information output by a specific device, and includes a first acquisition unit for acquiring an identifier corresponding to the specific device, and a second acquisition unit for establishing external communication that allows the information output by the specific device to be acquired using the identifier acquired by the first acquisition unit, to acquire the information, the second acquisition unit being different from the first acquisition unit.

In the acquired-information output terminal of the disclosure, the first acquisition unit may directly acquire the identifier from the specific device and/or accept direct input of the identifier.

In the acquired-information output terminal of the disclosure, the first acquisition unit may perform direct communication with the specific device to which the acquired-information output terminal has been brought close, using near field communication, to acquire the identifier. The second acquisition unit may directly or indirectly acquire the information output by the specific device via a communication unit that differs in a communication distance from the first acquisition unit.

In the acquired-information output terminal of the disclosure, the first acquisition unit may include a wireless communication reader for receiving the identifier from a wireless tag of the device. The second acquisition unit may include a wireless communication unit for establishing communication with the device using the identifier.

In the acquired-information output terminal of the disclosure, the second acquisition unit may establish communication with a management server for managing the information output by the device and continuously acquire, from the management server, the information of the device corresponding to the identifier obtained by the first acquisition unit.

The acquired-information output terminal of the disclosure may include a display unit for displaying the information output by the device.

The acquired-information output system of the disclosure is an acquired-information output system that includes a device that outputs information and an acquired-information output terminal that acquires the information output by the device. The acquired-information output terminal may include a first acquisition unit for acquiring an identifier corresponding to a specific device, a second acquisition unit for establishing communication and acquiring the information output by the specific device, and a display unit for displaying the information acquired by the second acquisition unit.

In the acquired-information output system of the disclosure, the first acquisition unit may directly acquire the identifier from the specific device and/or accept direct input of the identifier.

In the acquired-information output system of the disclosure, the first acquisition unit may perform direct communication with the device to which the acquired-information output terminal has been brought close, via near field communication, to acquire the identifier. The second acquisition unit may directly or indirectly acquire the information output by the device via a communication unit that differs in a communication distance from the first acquisition unit.

In the acquired-information output system of the disclosure, the device may include a wireless tag that stores the identifier. The first acquisition unit includes a wireless communication reader for receiving the identifier from the wireless tag of the device, and the second acquisition unit may include a wireless communication unit for establishing communication with the device using the identifier.

In the acquired-information output system of the disclosure, a management server may be provided for managing the information output by the device in association with the identifier of each device. The second acquisition unit may establish communication with the management server and continuously acquire, from the management server, the information of the device corresponding to the identifier acquired by the first acquisition unit.

In the acquired-information output system of the disclosure, the device may be disposed in a structure and include a sensor unit for measuring sensing information related to the structure, a storage unit for storing the sensing information measured by the sensor unit, and a transmission unit for transmitting the sensing information stored in the storage unit.

A communication method of the disclosure is a communication method for an acquired-information output terminal that directly or indirectly acquires the information output by a device. The method may include acquiring, by the acquired-information output terminal, an identifier corresponding only to a specific device, establishing communication for acquiring the information output by the device corresponding to the identifier, and continuously acquiring the information output by the device while communication is established.

In the communication method of the disclosure, the acquiring the identifier may include accepting direct input of the identifier.

In the communication method of the disclosure, the acquiring the identifier may include receiving the identifier from a wireless tag of the device to which the acquired-information output terminal has been brought close, via near field communication, and the acquiring the information output by the device may include establishing one-to-one wireless communication with the device corresponding to the identifier.

In the communication method of the disclosure, the acquiring the information output by the device may include establishing communication with a management server for managing the information output by the device and acquiring the information of the device corresponding to the identifier from the management server.

### Effects of the Disclosure

According to the disclosure, even when multiple communication sensor devices are present within a single area, it is possible to identify a specific communication sensor device and acquire only the information output by that communication sensor device, using a simple structure.

### BRIEF DESCRIPTION OF THE DRAWINGS

FIG. 1 is a block diagram showing an acquired-information output system according to a present embodiment.

FIG. 2 is a block diagram showing a configuration example of a sensor device.

FIG. 3 is a block diagram showing a configuration example of an acquired-information output terminal.

FIG. 4 is a flowchart showing an example of sensing information display processing by the acquired-information output system.

FIG. 5 is a block diagram showing another example of the acquired-information output system.

FIG. 6 is a block diagram showing a configuration example of a relay device.

FIG. 7 is a block diagram showing a configuration example of a management server.

FIG. 8 is a flowchart showing an example of connection processing between the sensor device and the relay device.

FIG. 9 is a flowchart showing an example of sensing information display processing by the acquired-information output system.

FIG. 10 is a flowchart showing an example of information display processing in a monitoring state.

FIG. 11 is a diagram showing an example of a deformation detection bolt.

FIG. 12 is a diagram showing an example of a structure.

FIG. 13 is a flowchart showing display processing of axial force and other information during tightening operation of the deformation detection bolt.

FIG. 14 is a block diagram showing a processing terminal with a switch mechanism according to the present embodiment.

FIG. 15 is a flowchart showing control processing associated with power-on.

### DETAILED DESCRIPTION

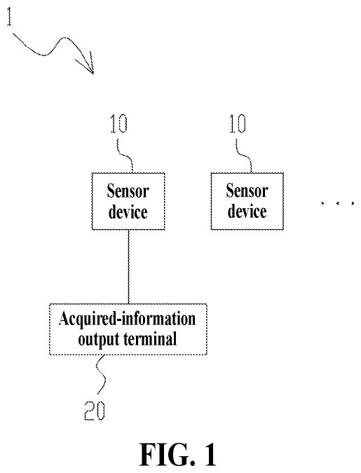

The embodiments of the acquired-information output system of the disclosure will be described below with reference to the drawings. FIG. 1 is a block diagram showing the acquired-information output system 1 according to the present embodiment. The acquired-information output system 1 is composed of at least multiple sensor devices 10 and an acquired-information output terminal 20.

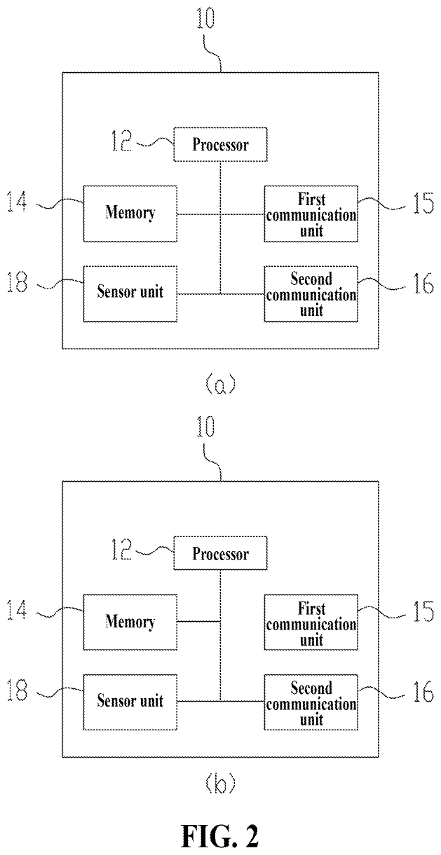

The sensor device 10 corresponds to an IoT device, a communication device, or a node related to these, and transmits the information measured by its sensing function to the acquired-information output terminal 20. FIG. 2 is a block diagram showing a configuration example of the sensor device 10. As shown in FIG. 2, Panel (a), the sensor device 10 includes a processor 12 that centrally controls the respective components of the sensor device 10. Connected to the processor 12 are a memory 14, a first communication unit 15, a second communication unit 16, a sensor unit 18, and the like. However, as shown in FIG. 2, Panel (b), the first communication unit 15 may be provided independently of the processor 12 and other components. Additionally, the processor 12 may have a timing function to measure time and a time period.

The memory 14 functions as a ROM, a RAM, or an NVM and stores an individual identifier set for each sensor device 10, as well as control programs, etc. The memory 14 also stores processing results from the processor 12. The processing results may include time information from an unillustrated clock function. Furthermore, the memory 14 may store data necessary for executing programs such as firmware and the results of executing such programs.

The first communication unit 15 includes an RFID (Radio Frequency Identification) tag, such as an NFC (Near Field Communication) tag, with control circuits, antennas, memory, and other components, and it is activated by radio waves or magnetic fields emitted by the acquired-information output terminal 20. The first communication unit 15 can transmit, for example, the individual identifier of the sensor device 10. Specifically, upon receiving radio waves or magnetic fields from the acquired-information output terminal 20, the first communication unit 15 uses the power generated in the antenna to transmit the individual identifier stored in its memory (which is the same as the identifier stored in the memory 14) back from the antenna via electromagnetic waves or magnetic fields. The first communication unit 15 is set to have a relatively short communication distance, such as close contact-based communication with a communication distance of 3 mm or less, or proximity-based wireless communication with a communication distance of 10 cm or less to very close distance, or the like.

The second communication unit 16 uses connection methods such as Wi-Fi®, Bluetooth®, or BLE (Bluetooth Low Energy), or so-called LPWA (Low Power Wide Area) to transmit and receive various types of information with the acquired-information output terminal 20. Additionally, the second communication unit 16 may have communication means such as the Internet or the Intranet, a mobile phone carrier communication, dedicated lines, or VPNs. It may utilize wireless LAN, WAN (wide area network), ISDNs (Integrated Service Digital Network), LTE (Long Term Evolution), LTE-Advanced, CDMA (Code Division Multiple Access), 5th Generation Mobile Communications System (5G), LPWA (Low Power Wide Area), etc., and, of course, public-switched telephone networks, optical lines, ADSL (Asymmetric Digital Subscriber Lines), satellite communication networks, or combinations thereof.

The sensor unit 18 is a sensor that measures sensing information related to physical states (e.g., one or more of various sensors such as a strain measuring sensor, a stress sensor, an axial force sensor, a pressure sensor, a temperature sensor, a humidity sensor, a barometric sensor, an acceleration sensor, an image sensor, an ultraviolet sensor, a radiation sensor, an orientation sensor, a flow sensor, a gas concentration sensor, etc.) and outputs the sensing information to the processor 12.

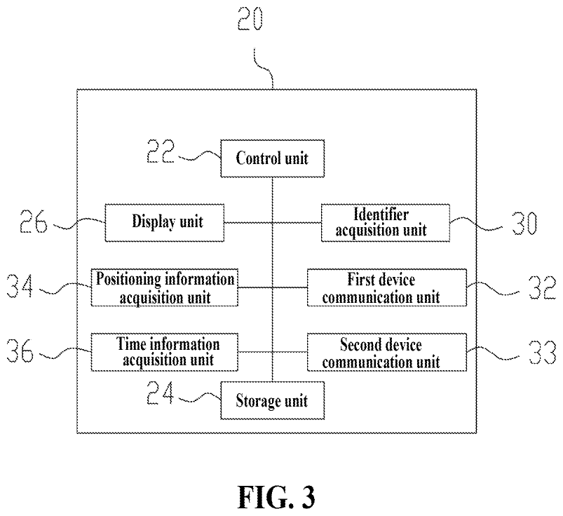

FIG. 3 is a block diagram showing a configuration example of the acquired-information output terminal 20. The acquired-information output terminal 20 includes a control unit 22 that centrally controls the respective components of the acquired-information output terminal 20. Connected to the control unit 22 are a storage unit 24, a display unit 26, an identifier acquisition unit 30, a first device communication unit 32, a second device communication unit 33, a positioning information acquisition unit 34, a time information acquisition unit 36, and the like.

The acquired-information output terminal 20 may take the form of any portable computing device, for example, a smartphone, tablet, an ultrabook, an e-book, a laptop computer, a tablet/laptop hybrid, a wearable terminal (e.g., a head-mounted display or a glasses-type device), a smartwatch, a media player, or a gaming device. Alternatively, some components may be externally connected, for example, allowing the identifier acquisition unit to function via an external connection. Naturally, it may also be a desktop PC, other types of computers, or the one equipped with computational circuits, monitors, and similar components.

The storage unit 24 stores the control program for the acquired-information output terminal 20 and also stores, for example, processing results from the control unit 22.

The display unit 26 displays information as instructed by the control unit 22. The information displayed on the display unit 26 may include at least information linked to a measurement value by the sensor device 10 and may also display individual identifiers (referred to simply as IDs) of the sensor devices 10 within the communication range of the acquired-information output terminal 20.

The identifier acquisition unit 30 includes a reader compatible with the wireless communication standard of the first communication unit 15 of the sensor device 10. For instance, if the first communication unit 15 has an RFID tag, the identifier acquisition unit 30 includes an RFID reader. The identifier acquisition unit 30 acquires information about the individual identifier (ID) from the first communication unit 15 of the sensor device 10.

The first device communication unit 32 has a function to communicate with at least the second communication unit 16 of the sensor device 10. Communication via the first device communication unit 32 may be established using communication means, such as the Internet, carrier communication, dedicated lines, or VPNs. For instance, communication may occur over wireless or wired networks, and specifically wireless LAN, WAN (wide area networks), ISDNs (Integrated Service Digital Networks), LTE (Long Term Evolution), LTE-Advanced, CDMA (Code Division Multiple Access), fifth-generation mobile communication systems (5G), LPWA (Low Power Wide Area), or the like may be utilized. Needless to say, networks may use Wi-Fi®, public switched telephone networks, Bluetooth®, BLE, optical lines, ADSL (Asymmetric Digital Subscriber Lines), satellite communication networks, or combinations thereof.

The second device communication unit 33 is a communication means capable of performing communication using a standard different from that of the first device communication unit 32. The communication is established through means such as the Internet, carrier communication, dedicated lines, or VPNs. For example, wireless or wired networks may be utilized, and specifically, wireless LAN, WAN (Wide Area Network), ISDNs (Integrated Service Digital Networks), LTE (Long Term Evolution), LTE-Advanced, CDMA (Code Division Multiple Access), fifth-generation mobile communication systems 5G, LPWA (Low Power Wide Area) or the like may be utilized. Needless to say, networks may use Wi-Fi®, public switched telephone networks, Bluetooth®, BLE, optical lines, ADSL (Asymmetric Digital Subscriber Lines), satellite communication networks, or combinations thereof.

The positioning information acquisition unit 34 acquires positioning information indicating the current location of the device. Examples of possible means of acquiring positioning information may include positioning systems such as a GPS (Global Positioning System), an LPS (Local Positioning System), an IMES (Indoor Messaging System), as well as a method for finding location information from image information, a method of creating spatial distance information using radar or laser, or combinations of two or more of these systems and methods.

The time information acquisition unit 36 has a means to acquire the latest time. For example, the time information acquisition unit 36 may acquire the latest time included in the GPS, or use a radio clock, the latest time information included in mobile phone carrier communication, or time information services via the Internet (e.g., NTP: Network Time Protocol) can be used. Alternatively, needless to say, the latest time may be obtained using a timing function.

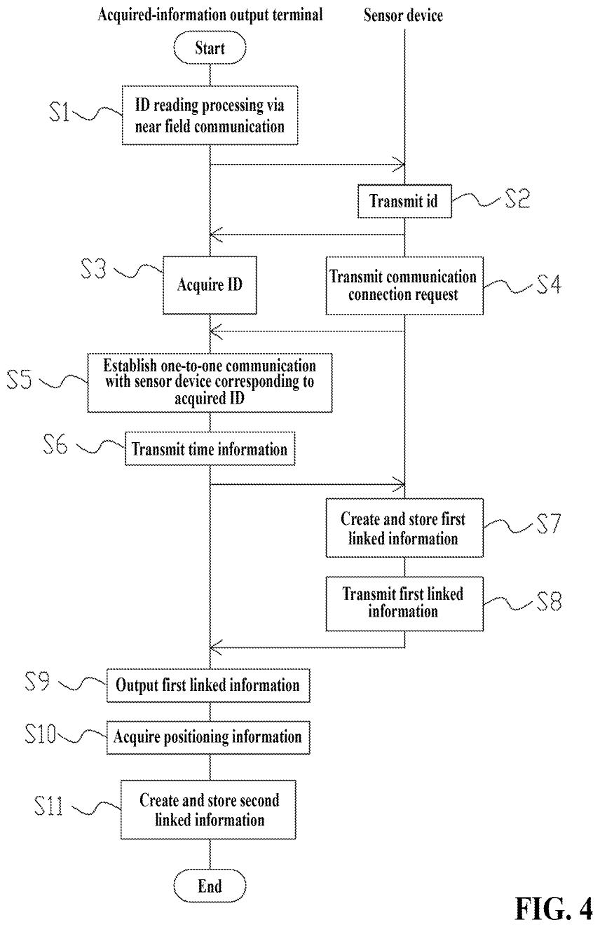

With reference to the flowchart in FIG. 4 that illustrates an example of sensing information display processing by the acquired-information output system 1, description will be made on an example of the processing for causing the acquired-information output terminal 20 to receive and display the sensing information from a specific sensor device 10.

Here, the acquired-information output terminal 20 is brought into proximity with the specific sensor device 10 to a distance where it can establish near field or very near field communication with the specific sensor device 10, such as RFID connection, that is, to a relative position where the acquired-information output terminal can acquire the ID from the specific sensor device 10 using the identifier acquisition unit 30. Additionally, the sensor device 10 is assumed to have its power activated when being installed and when communicating with the acquired-information output terminal 20, and to continuously transmit communication connection requests to find a connection target via the second communication unit 16. The power activation may be performed manually by the user of the acquired-information output terminal 20 or may be triggered upon receiving radio waves or electromagnetic waves from near field communication such as RFID connection to be described below.

The control unit 22 of the acquired-information output terminal 20 performs ID reading processing with a sensor device 10 with which the near field communication connection is possible, i.e., the sensor device that is within the range of the near field communication by the identifier acquisition unit 30 (Step S1). The sensor device 10 receives a radio wave of wireless communication via the near field communication connection, activates its first communication unit 15, and transmits its ID to the acquired-information output terminal 20 within the specified distance range (Step S2). The control unit 22 then receives and acquires the ID of the sensor device 10 (Step S3).

Furthermore, the processor 12 of the sensor device 10 transmits the communication connection request as described above (Step S4). The control unit 22 responds to the communication connection request and establishes one-to-one communication with the sensor device 10 corresponding to the acquired ID. Specifically, the control unit 22 transmits a response message with the ID acquired in Step S3 to the sensor device 10, thereby establishing one-to-one communication with the sensor device 10 corresponding to the specified ID (Step S5).

The control unit 22 acquires the latest time (approximately current time) using the time information acquisition unit 36 and transmits the acquired latest time as updated time information to the sensor device 10 (Step S6).

Upon receiving the updated time information, the processor 12 measures the sensing information with the sensor unit 18, creates first linked information that associates the sensing information, approximately current time, its own ID, etc., and stores the first linked information in the memory 14 (Step S7). Although it is not mandatory to store the first linked information in the memory 14, it is preferable to keep it stored at least until it is sent to the acquired-information output terminal 20.

The processor 12 transmits the first linked information to the acquired-information output terminal 20 at a preset timing (Step S8). The preset timing may be set to transmit the information at all times, but it may also be set to match a time (e.g., every second), or may be a time when a predetermined or greater change occurs in the sensing information. However, it is not limited to these and may be other timings settable as appropriate.

The control unit 22 outputs the received first linked information (Step S9). The output method at this time is not particularly limited, for instance, a state display screen based on the sensing information can be displayed on the display unit 26.

The control unit 22 acquires positioning information via the positioning information acquisition unit 34 (Step S10) and creates second linked information by associating the received first linked information with the positioning information. This second linked information is stored in the storage unit 24 (Step S11).

While communication between the acquired-information output terminal 20 and the sensor device 10 is maintained, the processes of transmitting the first linked information, displaying the state display screen, and storing the second linked information (Steps S6-S10) are repeated. When communication is disconnected, the physical state display processing ends.

Here, the disconnection of communication is assumed to occur due to the operation for disconnection performed by the user on the acquired-information output terminal 20.

As described above, the acquired-information output terminal 20 gets close to the sensor device 10 to a relative position where the near field communication is possible, acquires the ID, and uses the ID to acquire sensing information from the sensor device 10. Therefore, even in a case where multiple or numerous sensor devices 10 are densely packed within a predetermined space, it is possible to identify only a specific sensor device 10 among them and acquire and output the sensing information output by the specific sensor device 10.

Additionally, by simply bringing the acquired-information output terminal 20 close to the sensor device 10, the state display screen related to the sensing information of the sensor device can be displayed, which eliminates the need for the user of the acquired-information output terminal 20 to perform operations such as ID confirmation, pairing, and establishing one-to-one communication, thus improving usability.

Moreover, since the acquired-information output terminal 20 directly receives the first linked information from the sensor device 10, the communication distance is short, reducing the communication output. This reduces the influences of communication delays associated with transmission and reception of various types of information, enabling sensing information measured by the sensor device 10 to be displayed on the display unit 26 of the acquired-information output terminal 20 with almost no delay.

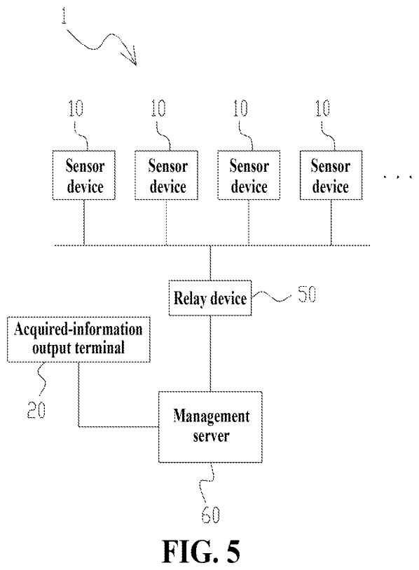

It should be noted that the acquired-information output system 1 is not limited to the above configuration. FIG. 5 is a block diagram that shows another example of the acquired-information output system 1. The acquired-information output system 1 in FIG. 5 includes multiple sensor devices 10, the acquired-information output terminal 20, a relay device 50, and a management server 60 that manages the sensing information for each sensor device 10. Each sensor device 10 is configured to be connectable to the acquired-information output terminal 20 and the relay device 50. Additionally, the acquired-information output terminal 20, the relay device 50, and the management server 60 can be connected to one another via a network.

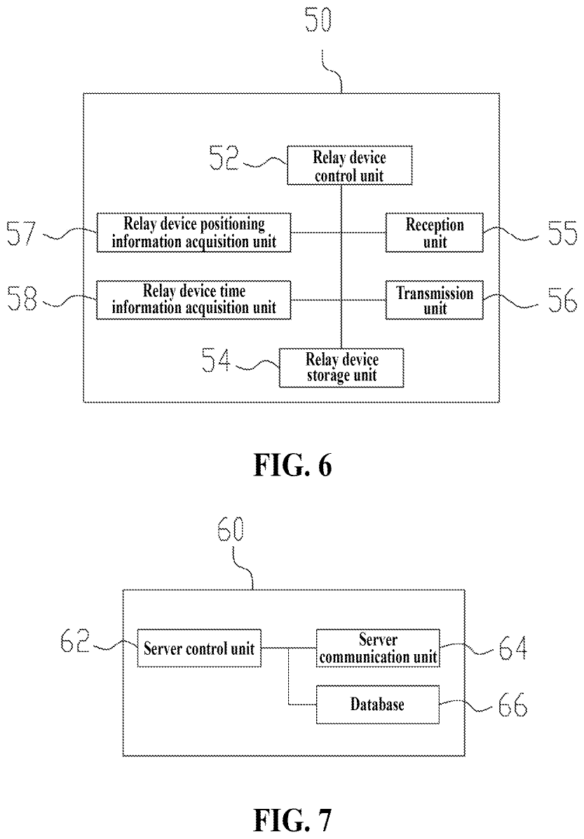

The relay device 50 is communicably connected to each sensor device 10 for communication. It receives and stores the sensing information transmitted from each sensor device 10 and transmits the received sensing information to the management server 60. FIG. 6 shows a block diagram of a configuration example of the relay device 50. The relay device 50 includes a relay device control unit 52 that centrally controls the respective components of the relay device 50. Connected to the relay device control unit 52 are a relay device storage unit 54, a reception unit 55, a transmission unit 56, a relay device positioning information acquisition unit 57, a relay device time information acquisition unit 58, etc.

The relay device storage unit 54 stores the control program for the relay device 50 and also saves processing results and the like from the relay device control unit 52.

The reception unit 55 has the function of receiving information from at least the second communication unit 16 of the sensor device 10 and includes communication means compatible with the standard of the second communication unit 16.

The transmission unit 56 has the function of transmitting information to at least the management server 60, and the communication can be established using communication means such as the Internet, carrier communication, dedicated lines, or VPNs. Communication may also occur over wireless or wired networks, and specifically wireless LAN, WAN (wide area networks), ISDNs (Integrated Services Digital Networks), LTE (Long Term Evolution), LTE-Advanced, CDMA (Code Division Multiple Access), fifth-generation mobile communication systems (5G), or LPWA (Low Power Wide Area), and the like may be utilized. Needless to say, networks may use Wi-Fi®, public switched telephone networks, Bluetooth®, BLE, optical lines, ADSL (Asymmetric Digital Subscriber Line), satellite communication networks, or combinations thereof.

The relay device positioning information acquisition unit 57 acquires positioning information indicating the current location. Examples of acquisition means for the positioning information include positioning systems such as the GPS (Global Positioning System), the LPS (Local Positioning System), the IMES (Indoor Messaging System), as well as a method for finding location information from image information, a method of creating spatial distance information using radar or laser, or combinations of two or more of these systems and methods.

The relay device time information acquisition unit 58 has a means for acquiring the latest time. For instance, the relay device time information acquisition unit 58 may obtain time information included in GPS, use a radio clock, or rely on time information included in the mobile phone carrier communication or time information services via the Internet (Network Time Protocol: NTP).

FIG. 7 is a block diagram showing a configuration example of the management server 60. The management server 60 includes a server control unit 62 that centrally controls the entire server. The server control unit 62 includes a CPU for executing programs and performing processing, and the ROM or the RAM for storing the programs, etc. Connected to the server control unit 62 are a server communication unit 64, a database 66, and the like. The server communication unit 64 includes a communication means compatible with the communication standards of the first device communication unit 32 and the transmission unit 56, enabling communication with the acquired-information output terminal 20, the relay device 50, and other components.

The database 66 stores the sensing information by associating the sensing information with the ID for each sensor device, time information of the time when the sensing information was measured, installation location information, and (not necessarily but) the individual identification information of the relay devices 50 that relayed the data.

The management server 60 also has, for example, a means to display the sensing information stored in the database 66 on the acquired-information output terminal 20. For instance, the management server 60 has a function for displaying a web page allowing viewing of the contents of the sensing information in the database 66 in response to access from the acquired-information output terminal 20 or transmitting the sensing information upon request, enabling the acquired-information output terminal 20 to download it.

The acquired-information output system 1 configured as described above allows the sensing information output by the sensor device 10 to be stored in the relay device 50 and transmitted from the relay device 50 via networks such as the Internet, carrier communication, dedicated lines, or VPNs to the management server 60 for storage and management.

After the communication with the acquired-information output terminal 20 is disconnected, the sensor device 10 establishes communication with the relay device 50 as the next connection partner.

The establishment of the communication between the sensor device 10 and the relay device 50 may be achieved by communication from the sensor device 10 to the relay device 50 or by the acquired-information output terminal 20 transmitting a command to the management server 60 to establish the communication between the relay device 50 and the sensor device 10.

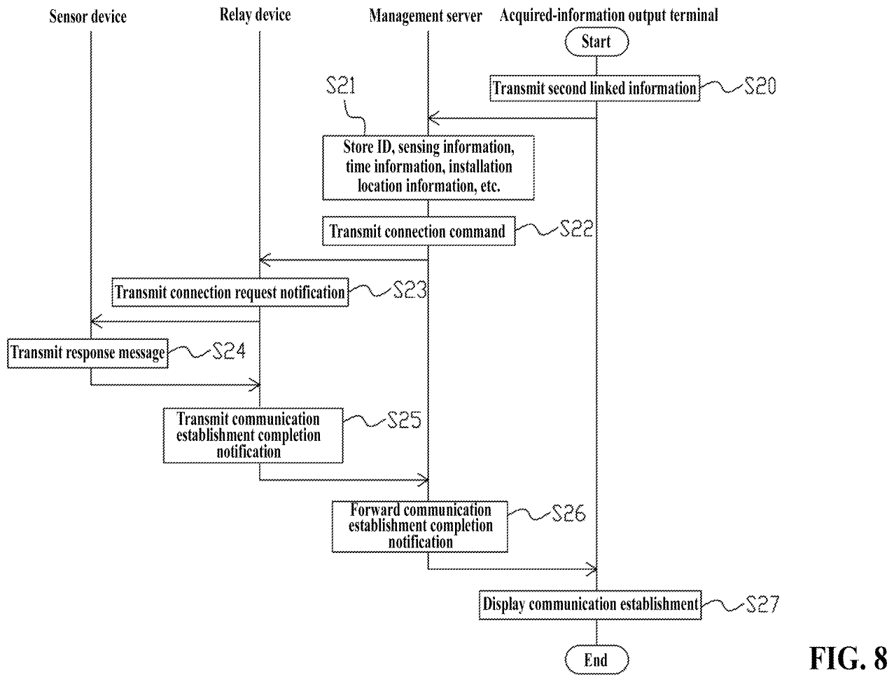

FIG. 8 shows a flowchart of an example of connection processing between the sensor device 10 and the relay device 50. This shows a connection processing example in which the acquired-information output terminal 20 transmits a command to the management server 60 to establish the communication between the relay device 50 and the sensor devices 10.

After Step S11 and the termination of the communication with the sensor device 10, the control unit 22 of the acquired-information output terminal 20 transmits the second linked information to the management server 60 (Step S20). Specifically, the control unit 22 reads the second linked information from the storage unit 24 and transmits the second linked information to the management server 60 via the second device communication unit 33.

The management server 60 extracts IDs, the sensing information, the time information, the positioning information, and other data from the received second linked information, and stores the extracted contents in the database associating them as the ID, the sensing information, the time information, and the installation location information of the sensor device 10 (Step S21). The positioning information is treated as the installation location information of the sensor device 10. In other words, the positioning information of the acquired-information output terminal 20, which was near the sensor device 10 during installation, regarded as the installation location information. This eliminates the trouble of storing the installation location information of each sensor device 10 in advance on the management server 60.

As a result, it becomes possible to install the sensor devices 10 without searching for a specific individual sensor device assigned to a preset installation position, from among a group of sensor devices that are before the installation, without pre-registering a sensor device to be installed for each installation location, and without worrying about the specific ID of the sensor device 10 for each installation location.

The management server 60 transmits a connection command attached with the extracted ID to the relay device 50 (Step S22). The relay device 50 transmits a connection request notification attached with the ID included in the received connection command (Step S23).

The processor 12 of the sensor device 10 verifies that the ID in the received connection request notification matches its own ID stored in the memory 14 and transmits a response message to connect and establish communication with the relay device 50 (Step S24). This response message includes the ID, etc., of the sensor device 10.

The relay device 50 transmits a communication establishment completion notification attached with the ID of the response message, to the management server 60 as a report on the result of the connection command (Step S25). The management server 60 forwards the communication establishment completion notification to the acquired-information output terminal 20 (Step S26). Based on the received communication establishment completion notification, the control unit 22 displays a message indicating that communication between the sensor device 10 and the relay device 50 has been established, thereby completing the process.

As a result of the above processing, the sensor device 10 is in a state where it is communicably connected to the relay device 50. Through this established communication, the sensor device 10 receives updated time information (approximately current time information) from the relay device 50, updates its time information, and measures the sensing information using the sensor unit 18 at the preset timing. Then, the sensor device 10 transmits the sensing information, associating with its own ID and other related data to the relay device 50. At this time, the sensor device 10 may also transmit the first linked information or other data that are stored in the storage unit 24 and have not yet been transmitted to the relay device 50.

Additionally, while establishing the communication with the relay device 50, the sensor device 10 can transition to the so-called monitoring state, where the frequencies of sensing information acquisition and information transmission to the relay device 50 is reduced compared to those when the sensor device 10 was establishing the communication with the acquired-information output terminal 20.

Thus, when the communication between the relay device 50 and the sensor device 10 is established via the management server 60, by the acquired-information output terminal 20 transmitting the command, the acquired-information output terminal 20 receives the results of the connection from the relay device 50. This allows the user of the acquired-information output terminal 20 to verify that the communication between the sensor device 10 and the relay device 50 has been established.

Furthermore, the acquired-information output terminal 20 transmits the contents of the stored second linked information to the management server 60 for storage, which enables the sensing information and other data acquired during the communication with the sensor device 10 to be reliably managed by the management server 60. This can also serve as a backup in the case where the sensor device 10 fails to establish communication with the relay device 50.

Moreover, as the sensor device 10 transitions to the monitoring state while establishing the communication with the relay device 50, it operates in a low-power state, minimizing the power consumption.

The method for establishing communication between the sensor device 10 and the relay device 50 is not limited to the above approach. For example, the communication connection request from the sensor device 10 may include a relay device ID for identifying the relay device 50. The relay device 50 can respond to this request to establish communication. In this case, the sensor device 10 may have the relay device ID in advance, or the relay device ID can be sent from the acquired-information output terminal 20 to the sensor device 10.

For instance, the relay device ID may be pre-stored in the storage unit 24, and the sensor device 10 can receive and acquire the relay device ID from the acquired-information output terminal 20 during the establishment of the communication between the acquired-information output terminal 20 and the sensor device 10. After disconnecting from the acquired-information output terminal 20, the sensor device 10 establishes communication with the relay device 50 associated with the acquired relay device ID and transmits the sensing information, information such as its own ID, and other data to the relay device 50 at a preset timing. Additionally, the relay device 50 may periodically transmit time information to update the time information measured in the sensor device 10.

The relay device 50 can also update its time information as needed. Methods for this include acquiring time information included in GPS, using a radio clock, relying on the time information included in mobile phone carrier communication, or time information services via the Internet (e.g., NTP: Network Time Protocol). The relay device 50 can also update, as needed, the time information of the sensor device 10 through wireless local NTP, i.e., or local radio clock methods. This enables precise correspondence between the timing of sensing information acquisition by the sensor unit 18 and the sensing information acquisition time.

The acquired-information output terminal 20 acquires the individual identifier of the sensor device 10 via near field communication using the identifier acquisition unit. However, the acquisition means of the individual identifier is not limited to this. For instance, the acquired-information output terminal 20 can store the individual identifier in advance, and in that case, a means such as a key-input of the individual identifier using an input means, not shown, such as a keyboard.

Additionally, visual information reading means, such as a scanner or a barcode reader, can be newly added or included (or may be additionally provided) as the identifier acquisition unit. The sensor device can have visual information, such as one-dimensional, two-dimensional, or other multi-dimensional codes, placed at visible locations on the external body of the sensor device. By reading the visual information using the visual information reading means, the individual identifier may be acquired. Thus, in a case where the individual identifier can be acquired without relying on the near field communication, the sensing information from the sensor device 10 can be grasped easily even if the sensor device 10 is located in an area where it is difficult to bring the acquired-information output terminal 20 into close proximity.

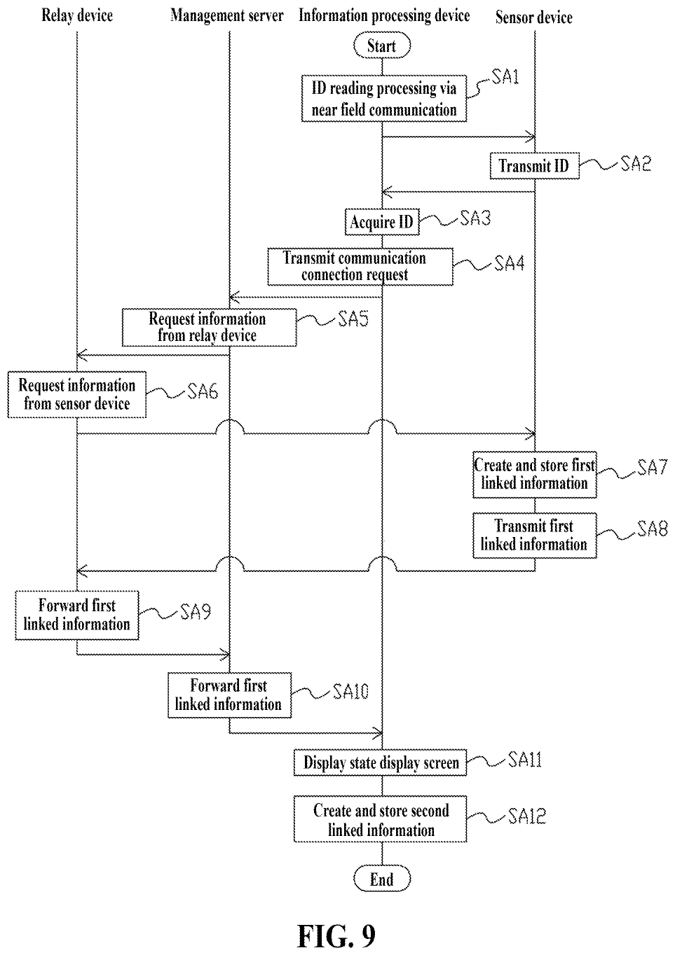

In the embodiment described above, the acquired-information output terminal 20 establishes communication with the sensor device 10, to receive the sensing information. However, it is also possible to establish communication between the acquired-information output terminal 20 and the management server 60 to receive the sensing information from the sensor device 10 via the management server 60. FIG. 9 is a flowchart showing an example of sensing information display processing by the acquired-information output system 1.

The acquired-information output terminal 20 and the sensor device 10 perform the same processing as in Steps S1 to S3. Specifically, the control unit 22 performs ID reading processing with the sensor device 10 via the near field communication (Step SA1). The sensor device 10 transmits its ID to the acquired-information output terminal 20 upon activation of the first communication unit 15 (Step SA2). Consequently, the control unit 22 acquires the ID of the sensor device 10 (Step SA3).

The control unit 22 transmits a communication connection request attached with the acquired ID, to the management server 60 via the first device communication unit 32 (Step SA4). The management server 60 establishes communication with the acquired-information output terminal 20 from which the communication connection request is accepted and transmits an information request to the relay device 50 to request sensing information from the sensor device 10 corresponding to the ID in the communication connection request (Step SA5).

The relay device 50 transmits the information request to the sensor device 10 corresponding to the ID in the information request (Step SA6). Upon receiving the information request, the processor 12 of the sensor device 10 measures the sensing information using the sensor unit 18, creates first linked information that associates the sensing information, the current time, and its own ID, etc., and stores it in the memory 14 (Step SA7). The processor 12 transmits the first linked information to the relay device 50 at the preset timing (Step SA8).

The relay device 50 forwards the first linked information to the management server 60 (Step SA9), and the management server 60 forwards the first linked information to the acquired-information output terminal 20 (Step SA10).

The control unit 22 displays a state display screen based on the sensing information, etc., in the received first linked information, on the display unit 26 (Step SA11). The control unit 22 acquires the positioning information using the positioning information acquisition unit 34, creates second linked information by associating the positioning information with the received first linked information, and stores the second linked information in the storage unit 24 (Step SA12). While the communication between the acquired-information output terminal 20 and the management server 60 is maintained, the processing in Steps SA5 to SA12 are repeated. When the communication is disconnected, the physical state display processing ends.

As described above, the acquired-information output terminal 20 gets close to the sensor device 10 to a relative position where the near field communication is possible, to acquire the ID, and obtains the sensing information from the sensor device 10 via the management server 60 and the relay device 50, while establishing communication with the management server 60 using the ID, thereby even in the case where multiple or numerous sensor devices 10 are densely packed in a predetermined space, it is possible to identify only a specific sensor device 10 from among the multiple or numerous sensor devices 10 and acquire the sensing information output from the specific sensor device 10.

The state display screen can display only the latest sensing information or the temporal changes in the sensing information over a certain past period. In the latter case, the acquired-information output terminal 20 can acquire multiple pieces of sensing information collected over a certain past period from the management server 60 (or from the relay device 50 via the management server 60) and display them in a list or a graph format such that the temporal changes in the sensing information can be recognized.

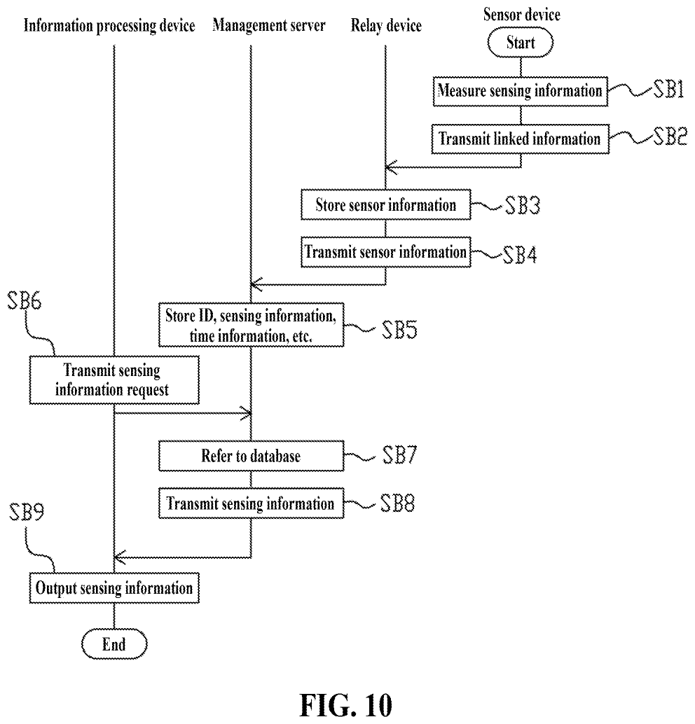

FIG. 10 is a flowchart showing an example of information display processing in the monitoring state. Here, the sensor device 10 has already established communication with the relay device 50 and is transmitting the sensing information at the preset timing. The flowchart shows output of the information when the sensing information measured by the sensor device 10 is monitored and confirmed via the acquired-information output terminal 20.

The processor 12 of the sensor device 10 receives updated time information from the relay device 50, updates the time information, and measures the sensing information using the sensor unit 18 at the preset timing (Step SB1). The processor 12 stores linked information associating the sensing information, the time information, and its own ID in the memory 14 and transmits the linked information to the relay device 50 via the second communication unit 16 (Step SB2). Note that, although the processor 12 transmits the linked information at the timing of sensing information acquisition, the processor 12 may transmit the linked information at a timing different from the timing of the sensing information acquisition.

The relay device 50 stores the received linked information (Step SB3) and transmits the linked information to the management server 60 (Step SB4).

The management server 60 extracts the ID, the sensing information, the time information, and the like from the received linked information and stores these in the database 66, by associating the respective extracted information with the ID (Step SB5). The steps so far constitute the storage processing of the sensing information performed at the preset timing in the monitoring state.

In the monitoring state, when the control unit 22 of the acquired-information output terminal 20 transmits a sensing information request attached with the ID of the sensor device 10 to be monitored to the management server 60 (Step SB6), the management server 60 reads the sensing information corresponding to the received ID from the database 66 (Step SB7). At this time, the latest sensing information is read from the database 66.

The management server 60 transmits the sensing information to the acquired-information output terminal 20 (Step SB8). The control unit 22 outputs the received sensing information (Step SB10). For instance, the control unit 22 can display the sensing information on the display unit 26. When the sensing information output is complete, the information display processing in the monitoring state ends.

Note that description has been made assuming that the acquired-information output terminal acquires IDs and the sensing information, but the acquired-information output terminal is not limited to a single device. It may be constituted of a device and a terminal that can be separated from each other. For instance, the acquired-information output terminal may include an RFID terminal with an identifier acquisition unit and a main device containing components other than the identifier acquisition unit, where the two are separable and communicable via wired connection or wirelessly.

In such a case, the RFID terminal acquires the identifier from the sensor device 10, and the main device acquires the sensing information. Furthermore, the RFID terminal sends the identifier to the main device, and the main device acquires the sensing information based on the identifier.

Additionally, the identifier held by the sensor device 10 does not need to completely match the identifier used for management by the management server 60, but partial match is acceptable. For example, the identifier used for management could combine the identifier held by the sensor device 10 with information about the building or location where the sensor device 10 is installed. In such cases, the acquired-information output terminal 20 can acquire its own location information via GPS or similar means, combine the location information with the identifier acquired from the sensor device 10, and transmit it to the management server 60, allowing it to correspond to the identifiers managed by the management server 60.

While the acquired-information output terminal displays the state display screen to show the sensing information, other methods can be used as long as the sensing information are recognizable at least by the user of the information processing device. For example, an additional speaker may be provided and the sensing information can be notified via audio reading the sensing information aloud or through simple or repetitive sounds such as buzzers, bells, or chimes. Furthermore, a vibration mechanism can be included to notify the sensing information through vibration patterns.

The aforementioned acquired-information output system 1 can also be configured without the relay device, that is, may be configured by including the sensor device 10, the acquired-information output terminal 20, and the management server 60. In such a configuration, the sensing information (or first linked information, etc.) transmitted by the sensor device 10 can be transmitted directly to the management server 60, or the sensing information (or first linked information, etc.) transmitted from the sensor device 10 and received by the acquired-information output terminal 20 can be transmitted from the acquired-information output terminal 20 to the management server 60.

Next, an application example of the acquired-information output system is described. In this example, deformation detection bolts are used as the sensor devices. The system can be applied to acquire raw data showing the tightening axial force or the physical state of the deformation detection bolts when multiple deformation detection bolts are used to fasten components together. A deformation detection bolt 100 is equipped with components such as the processor 12, the memory 14, the first communication unit 15, the second communication unit 16, the sensor unit 18, and the like, which are the components of the sensor device 10.

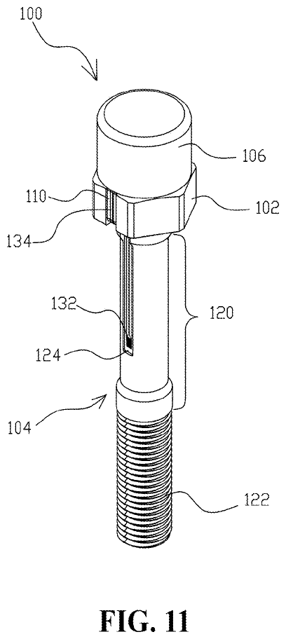

FIG. 11 illustrates an example of the deformation detection bolt 100. The deformation detection bolt 100 includes a head 102 and a shaft 104 and is configured to detect stresses such as bending stresses, compressive stresses, tensile stresses, and torsional stresses, and an axial force, which are applied to the deformation detection bolt 100.

Additionally, the deformation detection bolt 100 has a head cap 106 that is detachably mounted to the head 102. A circuit board constituting the respective parts of the above-described sensor device can be placed between the head 102 and the head cap 106 (e.g., on the top surface of the head 102). Thus, the head cap 106 can be used as a cover configured to cover the circuit board.

The head 102 has a hexagonal outer peripheral shape with three pairs of width across flats and has an outer shape in which a maximum dimension in the direction orthogonal to the bolt axis is larger than that of the shaft 104. The axial end of the head 102 is equipped with fixation means (not illustrated), such as fitting grooves, to secure the head cap 106. Additionally, the head 102 includes a current path placement section 110 with a recessed cross section for placing a current path 134 to be described later.

The shaft 104 has an outer shape in which its length along the axis is longer than its maximum dimension in the direction orthogonal to the axis. The shaft 104 includes a cylindrical section 120 located at the base or the seat surface side of the head 102, and a threaded section 122 with a male thread spiral groove formed on its outer peripheral surface.

The current path placement section 110 has a flat bottom surface on which the current path 134 is directly formed. The current path placement section 110 is integrally formed at least on the outer peripheral surface and the seat surface of the head 102. Specifically, the extending direction of the current path placement section 110 extends along the axis on the outer peripheral surface of the head 102 and orthogonal to the axis on the seat surface of the head 102. Needless to say, the extension direction of the current path placement section 110 can be set as needed, so as to extend in a direction inclined relative to the axis on the outer peripheral surface or in a direction inclined relative to a direction orthogonal to the axis on the seat surface. The depth and width of the recessed section can also be set appropriately.

The cylindrical section 120 has a cylindrical outer peripheral shape with a constricted portion 120a, where the outer diameter is reduced to create a partly constricted region relative to the entire shape. The length in the radial direction of this constricted portion 120a is set approximately equal to the root diameter or the pitch diameter of the male thread of the threaded section 122. Additionally, the cylindrical section 120 includes, on the outer peripheral surface thereof, a recessed sensor placement section 124 formed to be recessed along its axis.

The threaded section 122 includes a first male thread spiral structure and a second male thread spiral structure in a superposed manner. The first male thread spiral structure includes a spiral groove with a predetermined lead angle and/or lead direction and the second male thread spiral structure includes a spiral groove with a lead angle and/or lead direction different from the lead angle and/or lead direction of the first male thread spiral structure. The two types of the male screw spiral structures are superposed in the same region along the axis of the deformation detection bolt 100. For example, the first male thread spiral structure, which is a right-hand thread, can be screwed with a corresponding right-hand female thread spiral, and the second male thread spiral structure, which is a left-hand thread, can be screwed with a corresponding left-hand female thread spiral. Needless to say, the first and second male thread spiral structures may be set to have the same right-hand thread lead direction but different lead angles. The spiral grooves are not necessarily superposed, but it is preferable that they have a mechanism to prevent loosening as the joint members, in order to conduct precise and highly accurate strain and stress measurements.

The sensor placement section 124 extends from the intermediate position of the constricted portion 120a to the head 102 and is formed to be continuous with the current path placement section 110. The sensor placement section 124 has a substantially flat bottom surface on which a sensor pattern 132, used to detect the physical state of the shaft 104, is directly formed.

The sensor pattern 132 is part of the sensor unit 18 and can function as an axial force measurement sensor. The sensor pattern 132 is composed of a conductive material and includes a sensor structure portion that extends back and forth multiple times along the axis and a lead structure portion that extends from the sensor structure portion toward the head. In the sensor pattern 132, since electrical properties, such as resistance, change with deformation of the conductive material in the sensor structure portion, the axial force as a physical state can be detected by detecting the change in the electrical properties.

The physical state detected through the change in electrical properties may also include changes in heat, temperature, humidity, etc. For example, the sensor pattern 132 can function as a component of, what is called, a resistance thermometer, when an ambient temperature is measured, based on the change in the electrical resistance of the sensor pattern 132. Similarly, it can function as a resistive electric humidity sensor to measure humidity. The sensor pattern 132 is electrically connected to the current path 134 formed on the head 102 side.

The sensor pattern 132 can be implemented by forming an electrical insulation layer on the sensor placement section 124 and directly forming the sensor pattern on top of the electrical insulation layer. The electrical insulation layer can be created, for example, using methods such as laminated printing, pad printing, coating, plating, inkjet printing, sputtering, chemical vapor deposition (CVD), or physical vapor deposition (PVD). Note that the method for forming the electrical insulation layer is not limited to the above-described methods, but various other methods such as sputtering an insulation material, with a predetermined mask placed, to form a coating, applying silica materials followed by heat treatment, or applying organic insulating materials like silicone, polyimide, epoxy, or urethane, can also be adopted.

If the base material of the deformation detection bolt 100 is conductive, an oxide film can be formed on the surface of the base material through oxidation treatment, serving as the electrical insulation layer. If the based material is an aluminum-based material, an anodizing process can be performed to create the electrical insulation layer. Needless to say, if the base material itself has an electric insulation property, there is no need to form an electrical insulation layer.

The sensor pattern 132 can be directly formed on the electrical insulation layer using conductive paste via the methods such as laminated printing, pad printing, coating, plating, inkjet printing, sputtering, CVD, or PVD. Alternatively, the shape of the wiring can also be set by etching after applying a masking to match the shape of the sensor pattern 132.

The current path 134 can also be formed in the same manner as the sensor pattern, that is, an electrical insulation layer is formed on the current path placement section 110, and the current path 134 can be formed on the electrical insulation layer using a conductive paste. The current path 134 is formed to be continuous with the sensor pattern 132 and includes electrical contact pairs at its ends to connect to the circuit board. The direct formation of the sensor pattern 132 and the current path 134 on the electrical insulation layer prevents delamination over long periods.

As the change in the electrical properties of the sensor pattern 132, strain that occurs in the cylindrical section 120 or deformation of the cylindrical section 120 can be detected. Additionally, a coating layer with excellent abrasion resistance, scratch resistance, heat resistance, moisture barrier properties, solvent resistance, gas barrier properties, and deformation resistance (adhesion) may be applied to cover the sensor pattern 132 and the current path 134.

Next, the processing to be performed by the acquired-information output system 1, for detecting axial force or raw data for calculating the axial force (hereinafter referred to simply as “axial force, etc.”) when multiple deformation detection bolts 100 are used in a structure will be described, using the scene of tightening the deformation detection bolts 100 for the first time on the structure as an example.

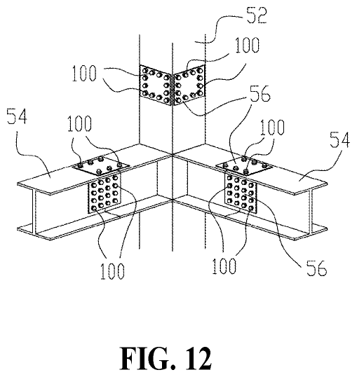

FIG. 12 illustrates an example of a structure. The structure is fastened with the deformation detection bolts 100 using connection plates 56, at multiple sites of the joining portions for connecting a support column 52, which is made of a square cylindrical steel member extending in the vertical direction, and at multiple sites of the joining portions for connecting so-called H-shaped beams 54, which is made of so-called H steel, extending in the horizontal direction from the support column 52.

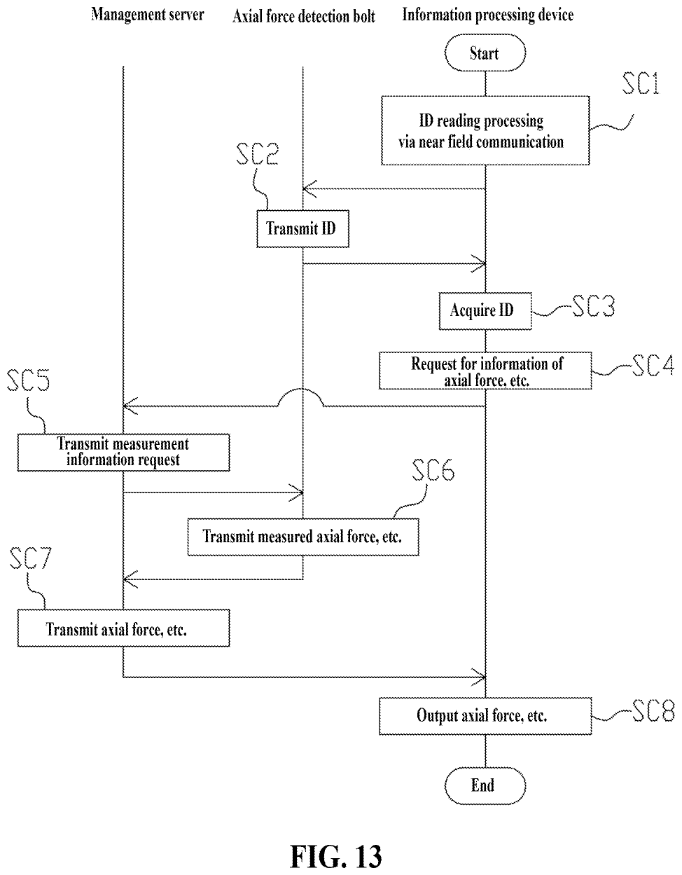

FIG. 13 is a flowchart illustrating the processing for displaying the axial force, etc., during the tightening operation of the deformation detection bolts 100. Here, it is assumed that the deformation detection bolts 100 has not yet established the communication with the relay device 50, such as in their shipped state. The worker activates the deformation detection bolts 100, for example, on-site and begins tightening the deformation detection bolts 100.

The acquired-information output terminal 20 is brought close to a specific deformation detection bolt 100 to a distance where the acquired-information output terminal 20 can establish the near field or very near field communication, such as RFID connection with the specific deformation detection bolt 100, that is, a relative position where the identifier acquisition unit 30 can acquire the ID from the deformation detection bolt 100. The deformation detection bolt 100 is powered on at the time of or just before the installation and at the time of establishing the communication with the acquired-information output terminal 20, and the deformation detection bolt 100 continuously transmits the communication connection requests to find a connection target via the second communication unit 16.

The control unit 22 performs ID reading processing with a deformation detection bolt 100 with which the near field communication connection is possible, that is, the deformation detection bolt 100 located within the range of near field communication by the identifier acquisition unit 30 (Step SC1). The deformation detection bolt 100 receives wireless communication radio waves via the near field communication connection, which activates the first communication unit 15, and transmits its ID to the acquired-information output terminal 20 within the specified distance range (Step SC2). The control unit 22 then receives and acquires the ID of the deformation detection bolt 100 (Step SC3).

The control unit 22 stores the acquired ID in the storage unit 24 and transmits a request for information of the axial force, etc., attached with the ID, to the management server 60 via the second device communication unit 33 (Step SC4).

Upon receiving the request for information of the axial force, etc., the management server 60 communicates with the deformation detection bolt 100 corresponding to the attached ID. Specifically, the management server 60 transmits a measurement information request to the deformation detection bolt 100 corresponding to the received ID (Step SC5).

The processor 12 of the deformation detection bolt 100 verifies that the ID in the received measurement information request matches its own ID stored in the memory 14. The processor 12 then transmits the axial force, etc., measured by the sensor unit 18, to the management server 60 via the second communication unit 16 (Step SC6). During this process, communication between the deformation detection bolt 100 and the management server 60 continues, and the axial force, etc., which are being measured by the sensor unit 18 of the deformation detection bolt 100 is transmitted to the management server 60.

The processor 12 stores the axial force, etc., measured by the sensor unit 18 in the memory 14, also during the communication with the management server 60.

The management server 60 transmits the received axial force, etc., to the acquired-information output terminal 20 (Step SC7). At this time, the management server 60 establishes communication with the acquired-information output terminal 20 and also with the deformation detection bolt 100. Consequently, the axial force, etc., acquired by the deformation detection bolt 100 at the preset timing are transmitted to the acquired-information output terminal 20 via the management server 60.

The control unit 22 outputs the received axial force, etc. (Step SC8). For example, the control unit 22 can display the axial force, etc., on the display unit 26. The worker can confirm the current axial force, etc., applied to the deformation detection bolt 100, by referring to the axial force, etc., displayed on the display unit 26, while tightening the deformation detection bolt 100 with a tightening tool and the like.

The control unit 22 ends the output (display) of the axial force, etc., in response to an operation to disconnect from the management server 60.

Note that it is needless to say that the axial force detection bolt 100 can communicate simultaneously with both the relay device 50 and the management server 60. In this case, the measured axial force, etc., can be transmitted to both the relay device 50 and the management server 60.

Note that the above description assumes that the acquired-information output terminal 20 establishes communication with the management server 60 to acquire the axial force, etc., but this is not a limitation. The acquired-information output terminal 20 can acquire the axial force, etc., directly from the axial force detection bolt 100.

In this case, the control unit 22 stores the ID in the storage unit 24 and transmits a communication connection request attached with the ID, to the axial force detection bolt 100 via the first device communication unit 32.

The processor 12 of the axial force detection bolt 100 establishes one-to-one communication with the acquired-information output terminal 20 when the ID in the received communication connection request matches the ID stored in the memory 14. The processor 12 transmits the axial force, etc., received by the sensor unit 18 to the acquired-information output terminal 20. As a result, the acquired-information output terminal 20 can display a state display screen showing the received axial force, etc.

More specifically, the acquired-information output terminal 20 and the axial force detection bolt 100 may establish wireless communication in compliance with the BLE standard. For example, the control unit 22 of the acquired-information output terminal 20 transmits a communication establishment request attached with the ID to the deformation detection bolt 100. When the processor 12 of the deformation detection bolt 100 responds with a confirmation of a match between the ID stored in the memory 14 and the received ID, the acquired-information output terminal 20 and the deformation detection bolt 100 make a pairing connection and establish wireless communication.

By allowing the acquired-information output terminal 20 to receive axial force, etc., directly from the axial force detection bolt 100 via the wireless communication, time lags and power consumption related to the communication can be reduced compared to transmitting axial force from the axial force detection bolt 100 to the relay device 50 or the management server 60.

The above processing was described using the example of tightening the deformation detection bolt 100 from the state not connected to the relay device 50. However, the same processing can be applied to display the state display screen also in the case of re-tightening of the deformation detection bolt 100, which has already been used for fastening the structure. In the case of the re-tightening of the already tightened deformation detection bolt 100, the deformation detection bolt 100 is already in communication with the relay device 50 and in the monitoring state. Therefore, the deformation detection bolt 100 is switched from the monitoring state to the axial force monitoring state. The method for such switching can be set as needed, such as switching through restart or reset of the deformation detection bolt 100, or operation for switching the states of the deformation detection bolt 100, for example. This switching causes the communication established between the deformation detection bolt 100 and the relay device 50 to be disconnected, enabling the acquired-information output terminal 20 to establish communication with the deformation detection bolt 100.

In the acquired-information output system 1 that employs the deformation detection bolts 100, when tightening each of the deformation detection bolts 100, the worker can use the state display screen to confirm the axial force, etc., each of the deformation detection bolts 100, which are generated by the tightening. By confirming the changes in the axial force corresponding to the tightening of the deformation detection bolt 100, the worker can adjust the tightening of the deformation detection bolt 100 to achieve the appropriate axial force.

The acquired-information output terminal 20 acquires, by the identifier acquisition unit 30, the identifier of the deformation detection bolt 100 to which the acquired-information output terminal 20 has been brought close to be almost in contact. This surely prevents the identifier acquisition unit 30 from simultaneously acquiring the identifiers from multiple deformation detection bolts 100. For the worker, this ensures that only the axial force of the desired deformation detection bolt 100 is grasped, even in the environment where multiple deformation detection bolts 100 are densely packed in a predetermined range. This eliminates the risk of misinterpretation caused by discrepancies between the displayed axial force and the deformation detection bolt 100, which is being tightened.

The axial force of the deformation detection bolt 100 is calculated by applying a unique constant, which can be set for each of the deformation detection bolts 100, to the raw data output by the sensor pattern 132. Therefore, in order to display the axial force, the axial force is calculated by performing predetermined calculations using the unique constant and raw data, in any of the deformation detection bolt 100, the relay device 50, the management server 60, and the acquired-information output terminal 20.

For instance, the memory 14 in each deformation detection bolt 100 may store the unique constant in advance, and the processor 12 can calculate the axial force using the output raw data and the unique constant and transmit the calculated axial force to the relay device 50 or the like. Alternatively, the relay device 50 can store the unique constant for each deformation detection bolt 100 and calculate the axial force using the raw data received from each of the deformation detection bolts 100 and the unique constant, to transmit the calculated axial force to the management server 60. Similarly, the management server 60 can store the unique constant for each deformation detection bolt 100 and calculate the axial force using the raw data and the unique constant, upon receiving the raw data each deformation detection bolt 100. Additionally, the acquired-information output terminal 20 can acquire the unique constant, and calculate the axial force using the raw data received from the management server 60 or the deformation detection bolts 100 and the unique constant.

The acquired-information output terminal 20 can acquire the unique constant through communication with the deformation detection bolt 100 or the management server 60, such as by acquiring the unique constant together with the identifier via the identifier acquisition unit 30.

### Switch Mechanism

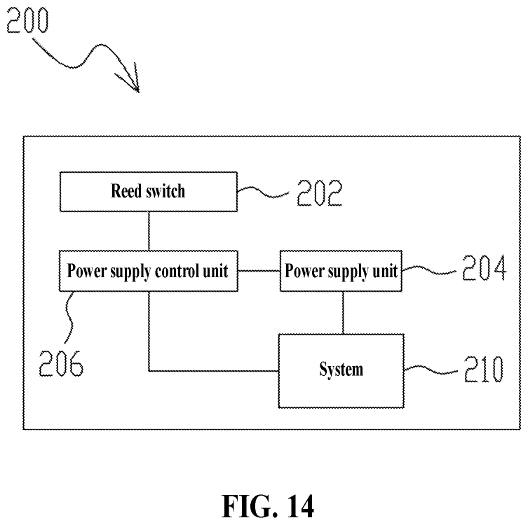

The following describes the switch mechanism of the disclosure, which can be applied to the sensor devices and deformation detection bolts mentioned above. The embodiment of a processing terminal equipped with the switch mechanism is explained with reference to the drawings. FIG. 14 is a block diagram showing the system configuration example of a processing terminal 200 according to the present embodiment. The processing terminal 200 includes a reed switch 202, a power supply unit 204, a power supply control unit (control means) 206, and a system (target circuit) 210, and the like. Any device incorporating the switch mechanism can serve as the processing terminal 200, including the aforementioned sensor devices and deformation detection bolts.

The reed switch 202 operates in response to an applied magnetic field, and performs opening and closing of the electrical circuit between the power supply unit 204 and the power supply control unit 206. The power supply unit 204 is a power supply device that includes external power sources, batteries (primary battery, secondary battery, etc.), or accumulators and supplies power to the components of the processing terminal 200.

The power supply control unit 206 controls the electrical circuit to various components and performs power supply judgment on the system 210 based on the on/off timing of the reed switch 202. The power supply control unit 206 may include a memory for storing, in advance, signal codes required for power supply judgment.

The power supply control unit 206 can include logic circuits, and the logic circuits may contain microcontrollers and/or microcomputers and/or microprocessors. The control means 206 can be configured by an electrical circuit. In other words, the power control can be implemented by an electrical circuit combining physical elements and wiring.

The power supply control unit 206 may include one or more FETs (field-effect transistors). FETs can be used to open and close the electrical circuit between the power supply unit 204 and the power supply control unit 206. For example, with two FETs, the first FET closes the electrical circuit between the power supply unit 204 and the power supply control unit 206 so that power is supplied only to the power supply control unit 206 in accordance with the closing of the reed switch 202, and the second FET closes the electrical circuit for supplying power to the power supply control unit 206, which has been activated. In other words, the second FET brings the electrical circuit between the power supply unit 204 and the power supply control unit 206 into a closed state, in order to ensure stable power supply, even after the reed switch 202 opens.

The system 210 is the main system configured for computations by the processing terminal 200. It may include hardware such as a CPU (Central Processing Unit), a memory, storage, a communication interface (I/F), a bus, and the like.

The CPU controls the entire system 210 and performs computations. The memory can include a ROM (Read-Only Memory) and a volatile storage device such as a RAM (Random Access Memory).

The storage can include non-volatile storage devices such as SSDs (Solid State Drives) and HDDs (Hard Disk Drives). The storage holds control programs and other programs run by the CPU, and data such as processing results from the CPU.

The communication I/F serves as an interface for connecting to networks. The bus connects the CPU, the storage unit, the communication I/F, and other components, enabling information exchange. Additionally, the system 210 may include input/output interfaces (I/O I/F) and other components, in addition to the above-described components.

The switch mechanism of the processing terminal 200 is configured to activate the power supply control unit 206 via a first operation that turns the reed switch 202 on using an external magnetic field. By performing a second operation that causes the reed switch 202 to turn on and off at least once or more using the external magnetic field, the system can be turned on to be driven or to be brought into a drivable state.

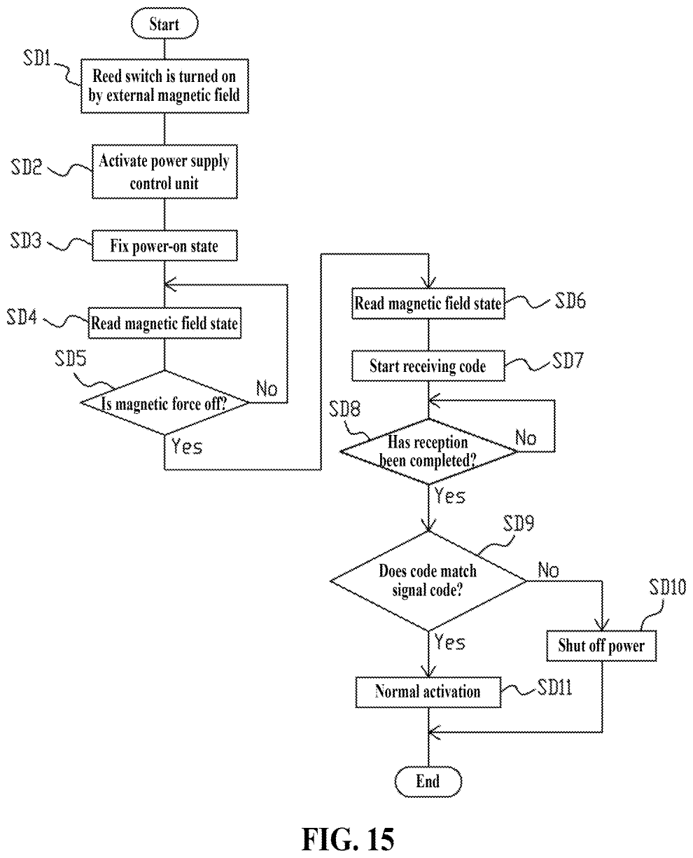

FIG. 15 is a flowchart illustrating the control processing associated with power-on operation. Here, as a means for powering on the processing terminal 200, the power-on operation is performed through the application of an external magnetic field. The external magnetic field is generated by a permanent magnet and/or an electromagnet. Specifically, the processing terminal 200 is powered on by bringing a power-on means equipped with a permanent magnet and/or electromagnet close to a specified part of the processing terminal 200 (e.g., near the reed switch 202) to turn on the power of the processing terminal 200. The first and second operations may be performed by the same power-on means, but in the present embodiment, different power-on means are used.

For the second operation, a power-on means for the second operation in which an external magnetic field that temporally and/or spatially varies is used. For example, the power-on means for the second operation switches between the state where the external magnetic field is applied to the reed switch 202 and the state where application of the external magnetic field to the reed switch 202 is stopped. Such a power-on means for the second operation causes a signal for power-on to be transmitted to the processing terminal 200. The signal transmitted at this time has a predetermined pattern. When the signal pattern matches the predetermined signal code, the entire processing terminal 200 is powered on.

The user of the processing terminal 200 brings the power-on means close to the reed switch 202 of the processing terminal 200. When this causes an external magnetic field to be applied and causes the reed switch 202 to be turned on (Step SD1), the first FET causes power to be supplied only to the power supply control unit 206 from the power supply unit 204, thereby activating the power supply control unit 206 (Step SD2). In other words, the first FET closes the electrical circuit between the power supply control unit 206 and the power supply unit 204.

Next, the power supply control unit 206 fixes its own power-on state (Step SD3). Specifically, the power supply control unit 206 drives the second FET to connect the power supply unit 204 and the power supply control unit 206 via the electrical circuit. This ensures that the activation state of the power supply control unit 206 is maintained even if the reed switch 202 is turned off during the control processing associated with the power-on operation.

The power supply control unit 206, after having been activated, monitors the reed switch 202 to read the state of the external magnetic field (referred to as the magnetic field state) (Step SD4) and determines whether the magnetic force has been turned off (Step SD5).

The user brings the power-on means close to the reed switch 202 and then moves it away from the reed switch 202, and thereafter brings the second power-on means close to the reed switch 202. The processing terminal 200 recognizes the proximity of the first power-on means in Step SD1 and determines, in Step SD5, whether the power-on means, the proximity of which has been recognized, is moved away.

While the power-on means is brought into proximity, the power supply control unit 206 determines that the magnetic force is “on” (Step SD5, No) and performs the processing in Steps SD4 to SD5 again to read the magnetic field state and determine whether the magnetic force has been turned “off.”

When the power-on means is moved away, the power supply control unit 206 determines that the magnetic force is “off” (Step SD5, Yes) and starts receiving codes via the reed switch 202 (Step SD6). In other words, when the worker brings the second power-on means close to the reed switch 202, a signal is transmitted by switching between applying and stopping of the external magnetic field. The power supply control unit 206 starts receiving this signal via the reed switch 202 (Step SD7).

The power supply control unit 206 determines whether reception of the signal has been completed (Step SD8). If the signal is still being received (Step SD8, No), the power supply control unit 206 determines again whether the reception of the signal is completed, while continuing the reception.

When the reception of the signal has been completed (Step SD8, Yes), the power supply control unit 206 recognizes the code based on the received signal and determines whether the recognized code matches the stored signal code (Step SD9). At this stage, part of the power supply control unit 206 functions as a signal judgment unit that determines whether the code matches the signal code.

If determination result indicates that the signal does not match the signal code (Step SD9, No), the power supply control unit 206 shuts off the power (Step SD10), to terminate the power-on processing.

On the other hand, if the received code matches the signal code (Step SD9, Yes), the power supply control unit 206 performs normal activation to supply power from the power supply unit 204 to the entire processing terminal 200 (Step SD11), and terminates the power-on processing. In this normal activation, power is supplied to the system 210, to drive the system 210 or bring the system 210 into the drivable state.

As described above, the power-on of the processing terminal can be performed by operating the reed switch. Additionally, the combination of the first and second operations can prevent the switch mechanism from erroneously powering on the target circuit by unintended external magnetic fields generated around the reed switch. Since the second operation requires transmitting the signal corresponding to the predetermined signal code, by configuring the signal code itself with detailed patterns and the like, occurrence of the malfunctions due to unintended external magnetic fields can be prevented.

Conventionally, there have been switches that are configured to switch the energized state and disconnected state through the contact and separation between a fixed-side terminal (hereinafter referred to as “contact terminal”) and a movable-side contact piece (hereinafter referred to as “movable contact piece”). These so-called contact switches often expose the switching mechanism externally.

However, such so-called contact switches often malfunction such as unintended on/off due to significant vibrations, and the like. Additionally, when the switching mechanism is exposed externally, unintended contact or the like may cause the switch to open or close. Furthermore, the weather resistance of the switch contact points may lead to problems such as poor contact.

To address this, the use of reed switches as non-contact switches has been considered. However, the reed switches are turned on or off by a magnetic force and operate when a magnet is brought close thereto. Therefore, reed switches are unintentionally turned on or off due to influences of external magnetic fields, which may cause malfunctions in terminals equipped with such reed switches.

This disclosure can provide a simple structure that can be disposed without external exposure of the switching mechanism and enables the target circuit to be driven by the reed switch via external magnetic field operation while reliably preventing malfunctions.

Moreover, since the switch mechanism can be disposed without exposing a part or all of its components externally, malfunctions due to vibrations or accidental contact with external objects can be effectively prevented. The design is not likely to be degraded or altered by wind, rain, sunlight, or temperature changes, which improves the weather resistance.

### EXPLANATION OF REFERENCE NUMERALS

1: Acquired-information output system
10: Sensor device
12: Processor
14: Memory
15: First communication unit
16: Second communication unit
18: Sensor unit
20: Acquired-information output terminal
22: Control unit
24: Storage unit
26: Display unit
30: Identifier acquisition unit
32: First device communication unit
33: Second device communication unit
34: Positioning information acquisition unit
36: Time information acquisition unit
50: Relay device
52: Relay device control unit
54: Relay device storage unit
55: Reception unit
56: Transmission unit
57: Relay device positioning information acquisition unit
58: Relay device time information acquisition unit
60: Management server
62: Server control unit
64: Server communication unit
66: Database
100: Deformation detection bolt
102: Head
104: Shaft
106: Head cap
110: Current path placement section
120: Cylindrical section
122: Threaded section
124: Sensor placement section
132: Sensor pattern
134: Current path
200: Processing terminal
202: Reed switch
204: Power supply unit
206: Power supply control unit
210: System

1. An acquired-information output terminal that acquires only information output by a specific device, comprising:
a first acquisition unit for acquiring an identifier corresponding to the specific device; and
a second acquisition unit for establishing external communication that allows the information output by the specific device to be acquired using the identifier acquired by the first acquisition unit, to acquire information, the second acquisition unit being different from the first acquisition unit.

2. The acquired-information output terminal according to claim 1, wherein the first acquisition unit is configured to directly acquire the identifier from the specific device and/or accept direct input of the identifier.

3. The acquired-information output terminal according to claim 1, wherein:
the first acquisition unit performs direct communication with the specific device to which the acquired-information output terminal has been brought close, using near field communication, to acquire the identifier, and
the second acquisition unit directly or indirectly acquires the information output by the specific device, via a communication unit-which-that differs in a communication distance from the first acquisition unit.

4. The acquired-information output terminal according to claim 3, wherein:
the first acquisition unit includes a wireless communication reader for receiving the identifier from a wireless tag of the specific device, and
the second acquisition unit includes a wireless communication unit for establishing communication with the specific device using the identifier.

5. The acquired-information output terminal according to claim 3, wherein:
the second acquisition unit establishes communication with a management server for managing the information output by the specific device and continuously acquires, from the management server, the information of the specific device corresponding to the identifier acquired by the first acquisition unit.

6. The acquired-information output terminal according to claim 1, further comprising a display unit for displaying the information output by the specific device.

7. An acquired-information output system comprising:
a device that outputs information; and
an acquired-information output terminal for acquiring the information output by the device, wherein:
the acquired-information output terminal includes:
a first acquisition unit for acquiring an identifier corresponding to a specific device,
a second acquisition unit for establishing communication and acquiring the information output by the specific device, and
a display unit for displaying the information acquired by the second acquisition unit.

8. The acquired-information output system according to claim 7, wherein the first acquisition unit is configured to directly acquire the identifier from the specific device and/or accept direct input of the identifier.

9. The acquired-information output system according to claim 7, wherein:
the first acquisition unit acquires the identifier by performing direct communication with the device to which the acquired-information output terminal has been brought close via near field communication, and
the second acquisition unit acquires the information output by the device directly or indirectly, via a communication unit that differs in a communication distance from the first acquisition unit.

10. The acquired-information output system according to claim 7, wherein:
the device includes a wireless tag storing the identifier,
the first acquisition unit includes a wireless communication reader for receiving the identifier from the wireless tag of the device, and
the second acquisition unit includes a wireless communication unit for establishing communication with the device using the identifier.

11. The acquired-information output system according to claim 9, further comprising a management server for managing the information output by the device in association with the identifier of each device, wherein:
the second acquisition unit establishes communication with the management server and continuously acquires, from the management server, the information of the device corresponding to the identifier acquired by the first acquisition unit.

12. The acquired-information output system according to claim 7, wherein the device is disposed in a structure and comprises:
a sensor unit for measuring sensing information related to the structure;
a storage unit for storing the sensing information measured by the sensor unit; and
a transmission unit for transmitting the sensing information stored in the storage unit.

13. A communication method for an acquired-information output terminal that acquires information output by a device directly or indirectly, comprising:
acquiring, by the acquired-information output terminal, an identifier corresponding only to a specific device;
establishing communication for acquiring the information output by the device corresponding to the identifier; and
continuously acquiring the information output by the device while the communication is established.

14. The communication method according to claim 13, wherein the acquiring the identifier comprising accepting direct input of the identifier.

15. The communication method according to claim 13, wherein:
the acquiring the identifier includes receiving the identifier from a wireless tag of the device to which the acquired-information output terminal has been brought close, via near field communication, and the acquiring the information output by the device includes establishing one-to-one wireless communication with the device corresponding to the identifier.

16. The communication method according to claim 13, wherein:
the acquiring the information output by the device includes establishing communication with a management server for managing the information output by the device and acquiring the information of the device corresponding to the identifier from the management server.
